(19) United States
(12) Patent Application Publication
(10) Pub. No.: US 2015/0331262 A1
(43) Pub. Date: Nov. 19, 2015

(54) OPTICAL MODULATOR, OPTICAL TRANSMITTER, OPTICAL TRANSMISSION/RECEPTION SYSTEM, AND CONTROL METHOD FOR OPTICAL MODULATOR

(71) Applicant: NEC Corporation, Tokyo (JP)

(72) Inventors: Hidemi NOGUCHI, Tokyo (JP); Tomoyuki YAMASE, Tokyo (JP)

(21) Appl. No.: 14/652,664

(22) PCT Filed: Jul. 17, 2013
(86) PCT No.: PCT/JP2013/004352

§ 371 Date: Jun. 16, 2015

(30) Foreign Application Priority Data
Dec. 20, 2012 (JP) 2012-278048

(51) Int. Cl. G02F 1/01; H04B 10/548

(52) U.S. Cl. CPC G02F 1/0121; G02F 1/011; H04B 10/548

(57) ABSTRACT

An optical modulation unit outputs an optical signal generated by binary-modulating an input light. Phase modulation areas are formed on an optical wave guide. A drive circuit includes a plurality of drivers outputting drive signals according to an input digital signal to the phase modulation areas. A determination circuit determines the driver to be activated among the plurality of the drivers based on information expressing a transmission rate. A driver control circuit activates the driver specified by a result of a determination of the determination circuit and cuts off power supply to the driver other than the activated driver. A switching circuit switches connections between the plurality of the drivers and the phase modulation areas. A switching control circuit that controls the switching circuit to cause the drive signals to be applied from the activated driver to the phase modulation areas.

### TECHNICAL FIELD

The present invention relates to an optical modulator, an optical transmitter, an optical transmission/reception system, and a control method for an optical modulator.

### BACKGROUND ART

With an explosive increase in demand of a broadband multimedia communication service such as the Internet or a high-definition digital TV broadcast, a dense wavelength-division multiplexing optical fiber communication system, which is suitable for a long-distance and large-capacity transmission and is highly reliable, has been introduced in trunk line networks and metropolitan area networks. In access networks, an optical fiber access service spreads rapidly. In such an optical fiber communication system, cost reduction for laying optical fibers as optical transmission lines and improvement of spectral efficiency per optical fiber are important. Therefore, a wavelength-division multiplexing technology which multiplexes multiple optical signals having different wavelengths is widely used.

In an optical transmitter for such a high-capacity wavelength-division multiplexing communication system, an optical modulator is required. In the optical modulator, high speed operation with small wavelength dependence is indispensable. Further, an unwanted optical phase modulation component which degrades the waveform of the received optical signal after long-distance transmission (in the case of using optical intensity modulation as a modulation method), or an optical intensity modulation component (in the case of using optical phase modulation as a modulation method) should be suppressed as small as possible. A Mach-Zehnder (MZ) optical intensity modulator in which waveguide-type optical phase modulators are embedded into an optical waveguide-type MZ interferometer is suitable for such a use.

To increase the transmission capacity per wavelength channel, a multilevel optical modulation signal system having a smaller optical modulation spectrum bandwidth than a typical binary optical intensity modulation system is advantageous in terms of the spectral efficiency, wavelength dispersion of an optical fiber, and resistance to polarization mode dispersion, each of which poses a problem. This multilevel optical modulation signal system is considered to become mainstream particularly in optical fiber communication systems in trunk line networks exceeding 40 Gb/s, the demand for which is expected to increase in the future. For such use, a monolithically integrated multilevel IQ optical modulator in which two MZ optical intensity modulators described above and an optical multiplexer/demultiplexer are used in combination has recently been developed.

In high speed optical modulation by using this optical modulator, especially in the high-frequency region in which the frequency of a modulation electric signal is over 1 GHz, the propagating wavelength of the modulation electric signal becomes not negligibly short compared with the length of an electrode formed in an optical phase modulator region in the optical modulator. Therefore, voltage distribution of the electrode serving as means for applying an electric field to the optical phase modulator is no longer regarded as uniform in an optical signal propagation axis direction. To estimate optical modulation characteristics exactly, it is required to treat the electrode as a distributed constant line and treat the modulation electric signal propagating through the optical phase modulator region as a traveling-wave, respectively. In that case, in order to increase the effective interaction length with the modulated optical signal and the modulation electric signal, a so-called traveling-wave type electrode which is devised to make a phase velocity vo of the modulated optical signal and a phase velocity vm of the modulation electric signal as close to each other as possible (phase velocity matching) is required.

An optical modulator module having a segmented electrode structure to realize the traveling-wave type electrode and the multilevel optical modulation signal system has already been proposed (Patent Literature 1 to 4). An optical modulator module capable of performing multilevel control of a phase variation of a modulated optical signal in each segmented electrode has also been proposed. This optical modulator module is a compact, broad-band, and low-drive-voltage optical modulator module capable of generating any multilevel optical modulation signal, while maintaining phase velocity matching and impedance matching, which are required for a traveling-wave structure operation, by inputting a digital signal.

### CITATION LIST

### Patent Literature

### Patent Literature 1: Japanese Unexamined Patent Application Publication No. 7-13112

### Patent Literature 2: Japanese Unexamined Patent Application Publication No. 5-289033

### Patent Literature 3: Japanese Unexamined Patent Application Publication No. 5-257102

Patent Literature 4: International Patent Publication No. WO 2011/043079

### SUMMARY OF INVENTION

### Technical Problem

However, the present inventor has found that the above-mentioned optical modulator module has the following problem. In the segmented electrode structure described above, a plurality of drivers for driving the segmented electrodes are normally required. In the case of a modulation operation, it is necessary to supply power to the plurality of the drivers. Thus, power consumption in the plurality of the drivers is large. Especially, number of the segmented electrodes increases when a multivalued-level increases. Accordingly, number of the drivers also increases. In this case, an increase in the power consumption is extremely prominent.

The present invention has been made in view of the above-mentioned problem, and an object of the present invention is to decrease power consumption of an optical transmitter including a segmented electrode structure.

### Solution to Problem

An aspect of the present invention is an optical modulator including: an optical modulation unit that outputs an optical signal generated by binary-modulating an input light, a plurality of phase modulation areas being formed on an optical wave guide in the optical modulation unit; a drive circuit that includes a plurality of drivers outputting drive signals according to an input digital signal to the plurality of the phase modulation areas; a determination circuit that determines the driver to be activated among the plurality of the drivers based on information expressing a transmission rate; a driver control circuit that activates the driver specified by a result of a determination of the determination circuit and cuts off power supply to the driver other than the activated driver; a switching circuit that switches connections between the plurality of the drivers and the plurality of the phase modulation areas; and a switching control circuit that controls the switching circuit to cause the drive signals to be applied from the activated driver to the plurality of the phase modulation areas.

An aspect of the present invention is an optical transmitter including: an optical modulation unit that outputs an optical signal generated by binary-modulating an input light, a plurality of phase modulation areas being formed on an optical wave guide in the optical modulation unit; a light source that outputs the input light; a drive circuit that includes a plurality of drivers outputting drive signals according to an input digital signal to the plurality of the phase modulation areas; a determination circuit that determines the driver to be activated among the plurality of the drivers based on information expressing a transmission rate; a driver control circuit that activates the driver specified by a result of a determination of the determination circuit and cuts off power supply to the driver other than the activated driver; a switching circuit that switches connections between the plurality of the drivers and the plurality of the phase modulation areas; and a switching control circuit that controls the switching circuit to cause the drive signals to be applied from the activated driver to the plurality of the phase modulation areas.

An aspect of the present invention is an optical transmission/reception system including: an optical transmitter that outputs an optical signal; and an optical receptor that receives the optical signal. The optical transmitter including: an optical modulation unit that outputs the optical signal generated by binary-modulating an input light, a plurality of phase modulation areas being formed on an optical wave guide in the optical modulation unit; a light source that outputs the input light; a drive circuit that includes a plurality of drivers outputting drive signals according to an input digital signal to the plurality of the phase modulation areas; a determination circuit that determines the driver to be activated among the plurality of the drivers based on information expressing a transmission rate; a driver control circuit that activates the driver specified by a result of a determination of the determination circuit and cuts off power supply to the driver other than the activated driver; a switching circuit that switches connections between the plurality of the drivers and the plurality of the phase modulation areas; and a switching control circuit that controls the switching circuit to cause the drive signals to be applied from the activated driver to the plurality of the phase modulation areas.

An aspect of the present invention is a control method for an optical modulator including; determining driver to be activated among a plurality of the drivers, the plurality of the drivers outputting drive signals according to an input digital signal to a plurality of phase modulation areas formed on an optical wave guide based on information expressing a transmission rate, the plurality of phase modulation areas modulating an input light that propagates through the optical wave guide; activating the driver specified by the determination, and cutting off power supply to the driver other than the activated driver; and switching connections between the plurality of the drivers and the plurality of the phase modulation areas to cause the drive signals to be applied from the activated driver to the plurality of the phase modulation areas.

### Advantageous Effects of Invention

According to the present invention, it is possible to decrease power consumption of an optical transmitter including a segmented electrode structure.

### BRIEF DESCRIPTION OF DRAWINGS

FIG. 1 is a block diagram schematically showing a configuration of a general multivalued optical transmitter 6000 including a segmented electrode structure.

FIG. 2 is a plane view schematically showing a configuration of an optical modulator 600.

FIG. 3A is a diagram schematically showing a configuration of an optical multiplexer/demultiplexer 613.

FIG. 3B is a diagram schematically showing a configuration of an optical multiplexer/demultiplexer 614.

FIG. 4 is a table of an operation showing an operation of the optical modulator 600.

FIG. 5 is a diagram schematically showing an aspect of propagation of a light in the optical modulator 600.

FIG. 6A is a constellation diagram of lights L1 and L2 when phase modulations by phase modulation areas PM61_1 to PM61_7 and phase modulation areas PM62_1 to PM62_7 are not applied.

FIG. 6B is a constellation diagram of the lights L1 and L2 when a binary code of an input digital signal is “000” in the optical modulator 600.

FIG. 6C is a constellation diagram of the lights L1 and L2 in the optical modulator 600.

FIG. 7 is a block diagram schematically showing a configuration of an optical transmitter 1000 according to a first embodiment.

FIG. 8 is a plane view schematically showing a configuration of an optical modulator 100 according to the first embodiment.

FIG. 9 is an equivalent circuit diagram when a p-i-n structure diode behaves as a capacitive load.

FIG. 10 is a graph showing a required transmission rate and band characteristics of the optical modulator 100.

FIG. 11 is a flowchart showing a method for deciding the activated driver in the optical modulator 100.

FIG. 12 is a plane view of the optical modulator 100 when the required transmission rate is high.

FIG. 13 is a plane view of the activated drivers and deactivated drivers of the optical modulator 100 when the required transmission rate is low.

FIG. 14 is a plane view schematically showing a configuration of an optical modulator 200.

FIG. 15 is a flowchart showing a method for deciding the activated driver in the optical modulator 200.

### DESCRIPTION OF EMBODIMENTS

Exemplary embodiments of the present invention will be described below with reference to the drawings. The same components are denoted by the same reference numerals throughout the drawings, and a repeated explanation is omitted as needed.

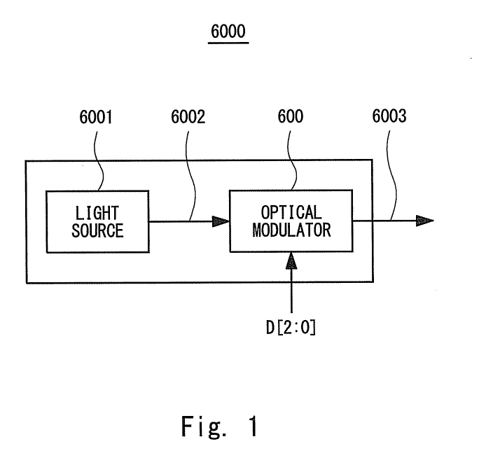

A general multivalued optical transmitter 6000, which includes a segmented electrode structure, shall be described as a premise for understanding a configuration and an operation of optical modulators according to following embodiments. The optical transmitter 6000 is a multivalued-modulation optical transmitter. However, the optical transmitter 6000 is described as a 3-bit optical transmitter for simplifying an explanation of that. FIG. 1 is a block diagram schematically showing a configuration of the general multivalued optical transmitter 6000 including the segmented electrode structure. The optical transmitter 6000 includes a light source 6001 and an optical modulator 600.

The light source 6001, which typically consists of a laser diode, outputs CW (Continuous Wave) light 6002 to the optical modulator 600, for example. The optical modulator 600 is a 3-bit optical modulator. The optical modulator 600 modulates the input CW light 6002 to output a 3-bit optical signal 6003 according to an input digital signal D[2:0] that is a 3-bit digital signal.

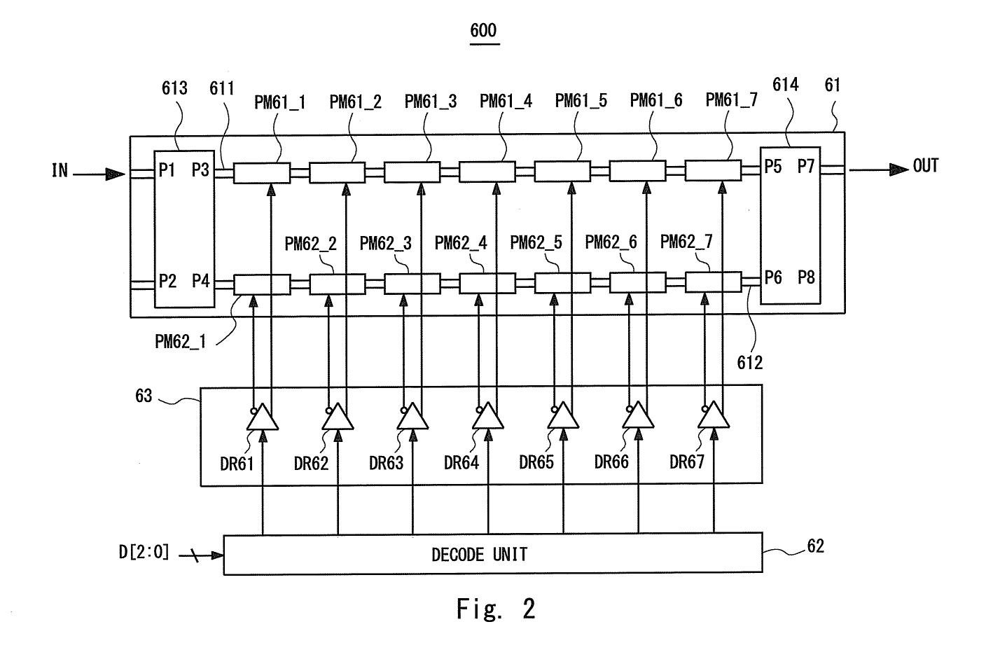

Next, the optical modulator 600 shall be described. FIG. 2 is a plane view schematically showing a configuration of the optical modulator 600. The optical modulator 600 includes an optical modulation unit 61, a decode unit 62, and a drive circuit 63.

The optical modulation unit 61 outputs an optical signal OUT modulated from an input light IN. Note that the input light IN corresponds to the CW light 6002 of FIG. 1. The optical signal OUT corresponds to the optical signal 6003 of FIG. 1. The optical modulation unit 61 includes optical wave guides 611 and 612, an optical multiplexer/demultiplexer 613, an optical multiplexer/demultiplexer 614, phase modulation areas PM61_1 to PM61_7 and PM62_1 to PM62_7. The optical wave guides 611 and 612 are arranged in parallel.

The optical multiplexer/demultiplexer 613 is inserted at a side of an optical signal input (the input light IN) of the optical wave guides 611 and 612. At an input side of the optical multiplexer/demultiplexer 613, the input light IN is input to an input port P1 and nothing is input to an input port P2. At an output side of the optical multiplexer/demultiplexer 613, the optical wave guide 611 is connected to an output port P3 and the optical wave guide 612 is connected to an output port P4.

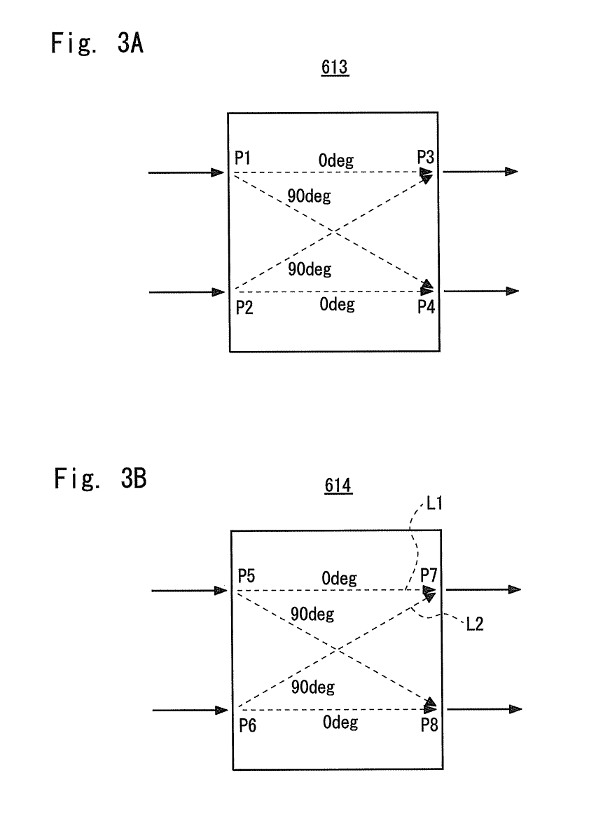

FIG. 3A is a diagram schematically showing a configuration of the optical multiplexer/demultiplexer 613. In the optical multiplexer/demultiplexer 613, the light incident on the input port P1 propagates to the output ports P3 and P4. However, a phase of the light propagating from the input port P1 to the output port P4 delays by 90 degrees as compared with the light propagating from the input port P1 to the output port P3. The light incident on the input port P2 propagates to the output ports P3 and P4. However, a phase of the light propagating from the input port P2 to the output port P3 delays by 90 degrees as compared with the light propagating from the input port P2 to the output port P4.

The optical multiplexer/demultiplexer 614 is inserted at a side of an optical signal output (the optical signal OUT) of the optical wave guides 611 and 612. At an input side of the optical multiplexer/demultiplexer 614, the optical wave guides 611 is connected to an input port P5 and the optical wave guides 612 is connected to an input port P6. At an output side of the optical multiplexer/demultiplexer 614, the optical signal OUT is output from an output port P7.

FIG. 3B is a diagram schematically showing a configuration of the optical multiplexer/demultiplexer 614. The optical multiplexer/demultiplexer 614 has the same configuration as the optical multiplexer/demultiplexer 613. The input ports P5 and P6 correspond to the input ports P1 and P2 of the optical multiplexer/demultiplexer 613, respectively. The output port P7 and an output port P8 correspond to the output ports P3 and P4 of the optical multiplexer/demultiplexer 613, respectively. The light incident on the input port P5 propagates to the output ports P7 and P8. However, a phase of the light propagating from the input port P5 to the output port P8 delays by 90 degrees as compared with the light propagating from the input port P5 to the output port P7. The light incident on the input port P6 propagates to the output ports P7 and P8. However, a phase of the light propagating from the input port P6 to the output port P7 delays by 90 degrees as compared with the light propagating from the input port P6 to the output port P8.

The phase modulation areas PM61_1 to PM61_7 are arranged on the optical wave guide 611 between the optical multiplexer/demultiplexer 613 and the optical multiplexer/demultiplexer 614. The phase modulation areas PM62_1 to PM62_7 are arranged on the optical wave guide 612 between the optical multiplexer/demultiplexer 613 and the optical multiplexer/demultiplexer 614.

Here, the phase modulation area is an area that includes one electrode (segmented electrode) formed on the optical wave guide. An effective refractive index of the optical wave guide below the electrode is changed by applying an electric signal, e.g., a voltage signal, to the electrode. As a result, a substantial optical length of the optical wave guide in the phase modulation area can be changed. Thus, the phase modulation area can change a phase of an optical signal propagating through the optical wave guide. Then, the optical signal can be modulated by providing the optical signals propagating through the two optical wave guides 611 and 612 with a phase difference. That is, the optical modulation unit 61 constitutes a multivalued Mach-Zehnder optical modulator that includes two arms and the segmented electrode structure.

The decode unit 62 decodes the 3-bit input digital signal D[2:0], and, for example, outputs multibit signals D1 to D7 to the drive circuit 63.

The drive circuit 63 includes binary drivers DR61 to DR67. The signals D1 to D7 are supplied to the drivers DR61 to DR67, respectively. The drivers DR61 to DR67 output a pair of the differential output signals according to the signals D1 to D7, respectively. In this case, in-phase output signals of the differential output signals output from the drivers DR61 to DR67 are output to the phase modulation areas PM61_1 to PM61_7, respectively. Reverse phase output signals of the differential output signals output from the drivers DR61 to DR67 are output to the phase modulation areas PM62_1 to PM62_7, respectively.

Here, the differential output signals output from the drivers DR61 to DR67 shall be described. As described above, the drivers DR61 to DR67 are binary output (0, 1) drivers. That is, the drivers DR61 to DR67 output “0” or “1” as the in-phase output signals according to values of the signals D1 to D7.

Meanwhile, the drivers DR61 to DR67 output inverted signals of the in-phase output signals as the reverse phase output signals. That is, the drivers DR61 to DR67 output “1” or “0” as the reverse phase output signals according to values of the signals D1 to D7.

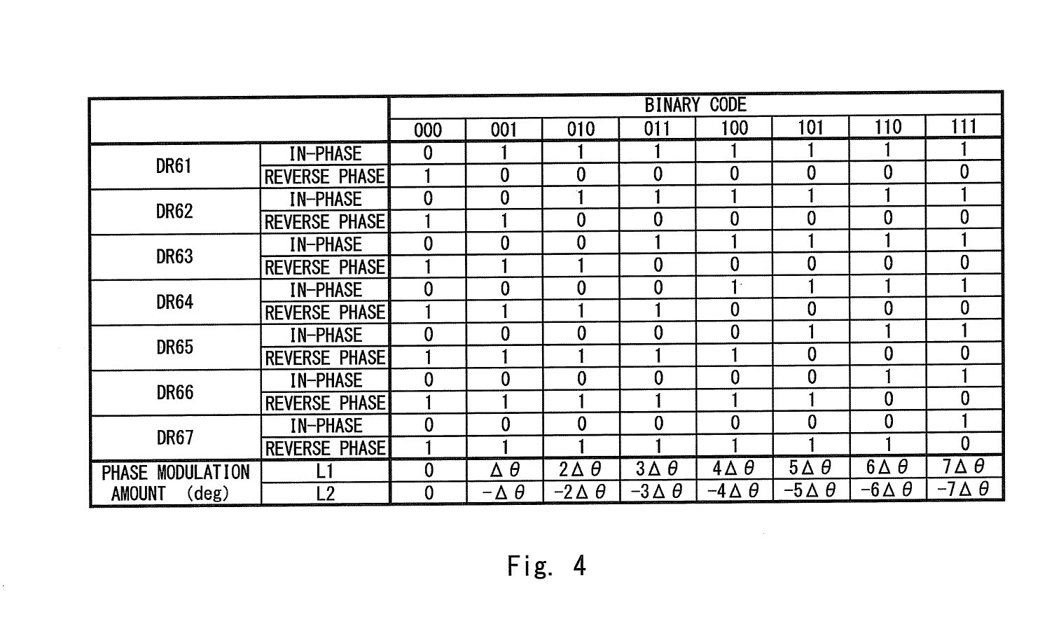

FIG. 4 is a table of an operation showing an operation of the optical modulator 600. The driver DR61 outputs “0” as the in-phase output signal and “1” as the reverse output signal when the input digital signal D[2:0] is “000”. The driver DR61 outputs “1” as the in-phase output signal and “0” as the reverse output signal when the input digital signal D[2:0] is equal to or larger than “001”.

The driver DR62 outputs “0” as the in-phase output signal and “1” as the reverse output signal when the input digital signal D[2:0] is equal to or less than “001”. The driver DR62 outputs “1” as the in-phase output signal and “0” as the reverse output signal when the input digital signal D[2:0] is equal to or larger than “010”.

The driver DR63 outputs “0” as the in-phase output signal and “1” as the reverse output signal when the input digital signal D[2:0] is equal to or less than “010”. The driver DR63 outputs “1” as the in-phase output signal and “0” as the reverse output signal when the input digital signal D[2:0] is equal to or larger than “011”.

The driver DR64 outputs “0” as the in-phase output signal and “1” as the reverse output signal when the input digital signal D[2:0] is equal to or less than “011”. The driver DR64 outputs “1” as the in-phase output signal and “0” as the reverse output signal when the input digital signal D[2:0] is equal to or larger than “100”.

The driver DR65 outputs “0” as the in-phase output signal and “1” as the reverse output signal when the input digital signal D[2:0] is equal to or less than “100”. The driver DR65 outputs “1” as the in-phase output signal and “0” as the reverse output signal when the input digital signal D[2:0] is equal to or larger than “101”.

The driver DR66 outputs “0” as the in-phase output signal and “1” as the reverse output signal when the input digital signal D[2:0] is equal to or less than “101”. The driver DR66 outputs “1” as the in-phase output signal and “0” as the reverse output signal when the input digital signal D[2:0] is equal to or larger than “110”.

The driver DR67 outputs “0” as the in-phase output signal and “1” as the reverse output signal when the input digital signal D[2:0] is equal to or less than “110”. The driver DR67 outputs “1” as the in-phase output signal and “0” as the reverse output signal when the input digital signal D[2:0] is “111”.

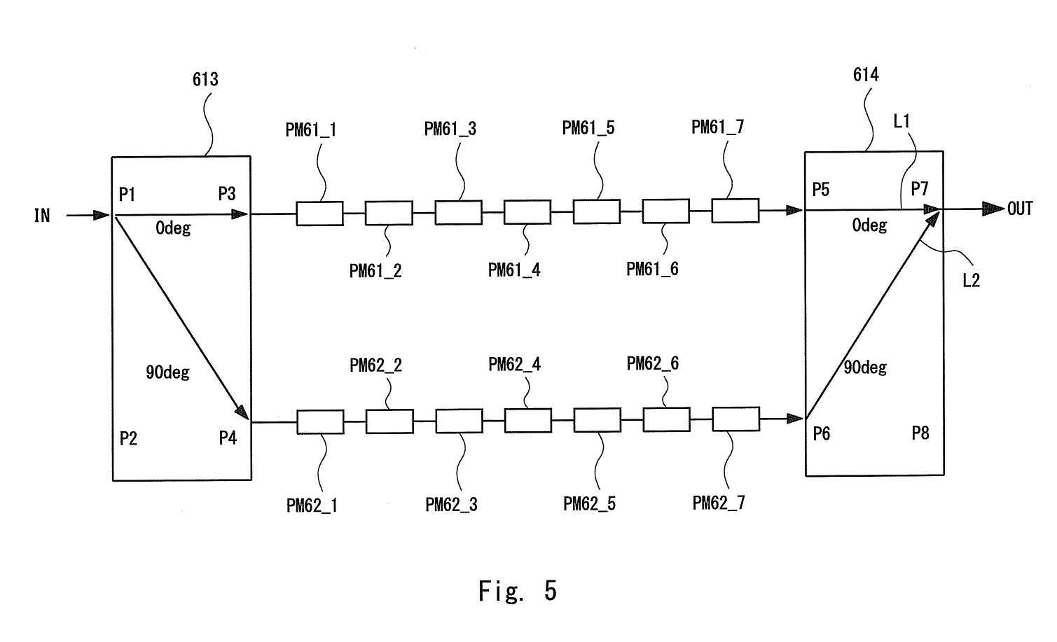

Here, a phase modulation operation of the optical modulator 600 shall be described. FIG. 5 is a diagram schematically showing an aspect of propagation of the light in the optical modulator 600. In this example, as shown in FIG. 5, the input light IN is incident on the input port P1 of the optical multiplexer/demultiplexer 613. Thus, the phase of the light output from the output port P4 is delayed by 90 degrees as compared with the light output from the output port P3. After that, the light output from the output port P3 passes through the phase modulation areas PM61_1 to PM61_7 and reaches the input port P5 of the optical multiplexer/demultiplexer 614. The light reaching the input port P5 reaches the output port P7 as-is. Meanwhile, the light output from the output port P4 passes through the phase modulation areas PM62_1 to PM62_7 and reaches the input port P6 of the optical multiplexer/demultiplexer 614. The light reaching the input port P6 the phase of which is further delayed by 90 degrees reaches the output port P7.

In other words, a phase of a light L2 reaching the output port P7 from the input port P6 is delayed by 180 degrees as compared with a light L1 reaching the output port P7 from the input port P5 when the phase modulations by the phase modulation areas PM61_1 to PM61_7 and phase modulation areas PM62_1 to PM62_7 are not applied.

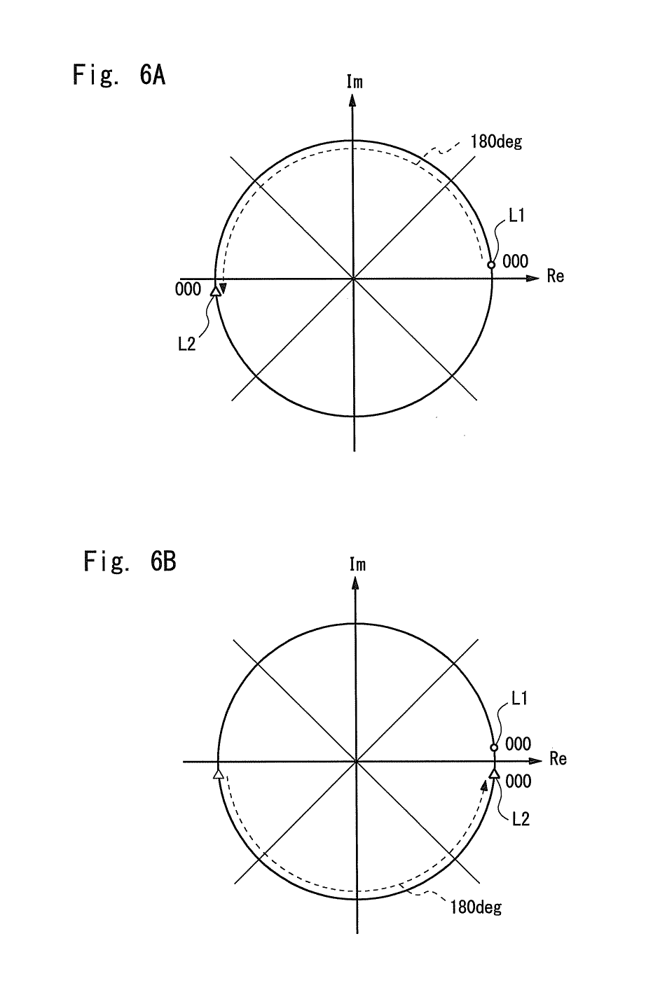

FIG. 6A is a constellation diagram of the lights L1 and L2 when the phase modulations by the phase modulation areas PM61_1 to PM61_7 and phase modulation areas PM62_1 to PM62_7 are not applied. As described above, the phase of the light L2 reaching the output port P7 from the input port P6 is delayed by 180 degrees as compared with the light L1 reaching the output port P7 from the input port P5.

On the other hand, in the optical modulator 600, the in-phase output signals are input to the phase modulation areas PM61_1 to PM61_7 and the reverse phase output signals are input to the phase modulation areas PM62_1 to PM62_7. Therefore, the delay of the phase of the light L2 reaching the output port P7 from the input port P6 is compensated.

FIG. 6B is a constellation diagram of the lights L1 and L2 when a binary code of the input digital signal D[2:0] is “000” in the optical modulator 600. For example, when the binary code of the input digital signal D[2:0] is “111”, “1”, which is the in-phase output signal, is input to each of the phase modulation areas PM61_1 to PM61_7. Meanwhile, “0”, which is the reverse phase output signal, is input to each of the phase modulation areas PM62_1 to PM62_7. Thus, the phase of the light passing through the phase modulation areas PM62_1 to PM62_7 is further delayed by 180 degrees.

That is, not only the original 180 degrees phase delay but also 180 degrees which is the phase delay by the phase modulation areas PM62_1 to PM62_7 are added to the light L2 reaching the output port P7 from the input port P6. Thus, in the light L2 reaching the output port P7 from the input port P6, the phase delay of 360 degrees occurs. Therefore, the phase delay with respect to the light L1 reaching the output port P7 from the input port P5 is resolved.

FIG. 6C is a constellation diagram of the lights L1 and L2 in the optical modulator 600. As shown in FIG. 6C, a D/A conversion in the optical transmitter can be thereby achieved, because each of the light phases of L1/L2 is varied asymmetrically with respect to an Re axis while the phase delay of the light L2 reaching the output port P4 from the input port P1 and reaching the output port P7 from the input port P6 is compensated according to the variation of the input digital signal D[2:0] by using the differential output signal. Therefore, as shown in the table of FIG. 4, a phase modulation amount of the light L1 can be varied in eight levels of 0 to 7Δθ, and a phase modulation amount of the light L2 can be varied in eight levels of 0 to −7Δθ according to the input digital signal D[3:0].

In FIGS. 6B and 6C, when the binary code of the input digital signal D[2:0] is “000” or “111”, the positions of the lights L1 and L2 are not coincident, however, it is merely for making the drawings be easily viewable. That is, the positions of the lights L1 and L2 may be coincident when the binary code of the input digital signal D[2:0] is “000” or “111”. Here, an example in which the phase variation amount modulated by the phase modulation areas is varied in the range of 0 to 180 degrees according to the input digital signal is described. However, it is not limited to this example.

### First Embodiment

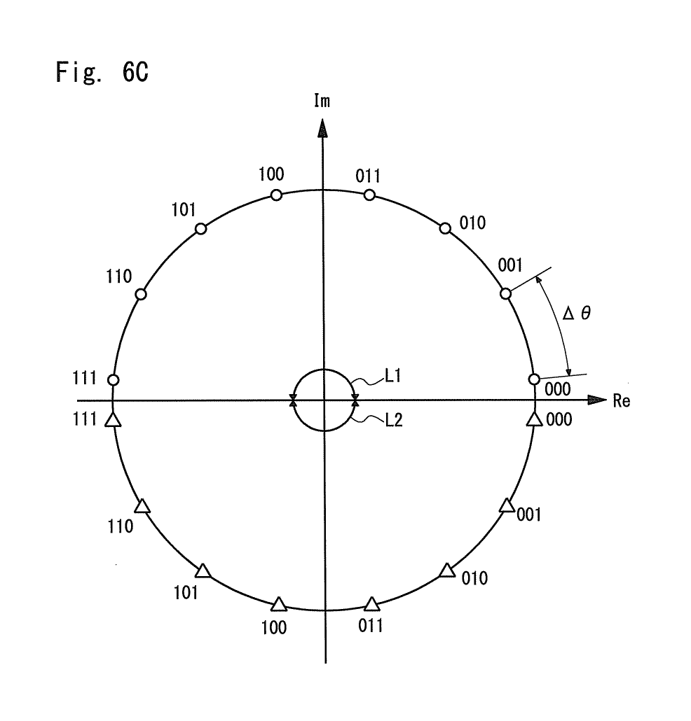

An optical transmitter 1000 according to a first embodiment of the present invention shall be described. The optical transmitter 1000 is an optical transmitter that preforms a binary (i.e., 1-bit) modulation operation. FIG. 7 is a block diagram schematically showing a configuration of the optical transmitter 1000 according to the first embodiment. The optical transmitter 1000 includes a light source 1001 and an optical modulator 100.

The light source 1001, which typically consists of a laser diode, outputs CW (Continuous Wave) light 1002 to the optical modulator 100, for example. The optical modulator 100 is a binary (1-bit) optical modulator. The optical modulator 100 modulates the input CW light 1002 to output a binary optical signal 1003 according to an input digital signal DIN that is a binary digital signal.

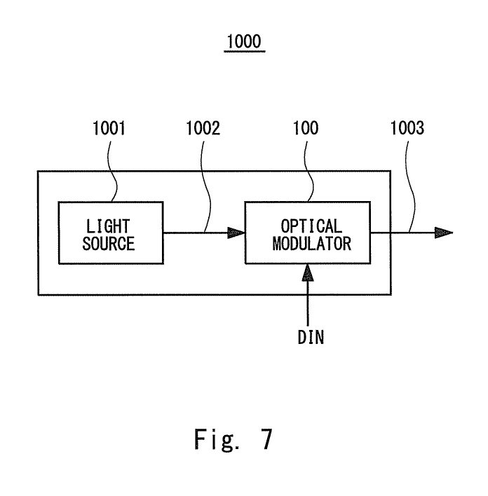

Next, the optical modulator 100 shall be described. The optical modulator 100 has the segmented electrode structure as in the case of the optical modulator 600 described above. FIG. 8 is a plane view schematically showing a configuration of the optical modulator 100 according to the first embodiment. The optical modulator 100 includes an optical modulation unit 11, a drive circuit 12, a determination circuit 13, a driver control circuit 14, a driver-output switching circuit 15, and a switching control circuit 16.

The optical modulation unit 11 includes optical wave guides 111 and 112, an optical multiplexer/demultiplexer 113, an optical multiplexer/demultiplexer 114, phase modulation areas PM1_1 to PM1_7 and PM2_1 to PM2_7. The optical wave guides 111 and 112 correspond to a first and second wave guides, respectively. The optical multiplexer/demultiplexer 113 and optical multiplexer/demultiplexer 114 correspond to a first optical multiplexer/demultiplexer and a second optical multiplexer/demultiplexer, respectively. The phase modulation areas PM1_1 to PM1_7 correspond to first phase modulation areas. The phase modulation areas PM2_1 to PM2_7 correspond to second phase modulation areas. The optical modulation unit 11 has a structure of a so-called Mach-Zehnder optical resonator in which segmented electrodes (the phase modulation areas PM1_1 to PM1_7 and PM2_1 to PM2_7) are provided on two optical wave guides (the optical wave guides 111 and 112).

The optical wave guides 111 and 112 are arranged in parallel. The optical multiplexer/demultiplexer 113 is inserted at a side of an optical signal input (an input light IN) of the optical wave guides 111 and 112. The optical multiplexer/demultiplexer 113 has the same configuration as the optical multiplexer/demultiplexer 613 described above. At an input side of the optical multiplexer/demultiplexer 113, the input light IN is input to an input port P1 and nothing is input to an input port P2. At an output side of the optical multiplexer/demultiplexer 113, the optical wave guide 111 is connected to an output port P3 and the optical wave guide 112 is connected to an output port P4. Note that the input light IN corresponds to the CW light 1002 of the FIG. 7.

The optical multiplexer/demultiplexer 114 is inserted at a side of an optical signal output (the optical signal OUT) of the optical wave guides 111 and 112. The optical multiplexer/demultiplexer 114 has the same configuration as the optical multiplexer/demultiplexer 614 described above. At an input side of the optical multiplexer/demultiplexer 114, the input light IN is input to an input port P5 and nothing is input to an input port P6. At an output side of the optical multiplexer/demultiplexer 114, the optical signal OUT is output from an output port P7. Note that the optical signal OUT corresponds to the optical signal 1003 of the FIG. 7.

The phase modulation areas PM1_1 to PM1_7 are arranged on the optical wave guide 111 between the optical multiplexer/demultiplexer 113 and the optical multiplexer/demultiplexer 114. The phase modulation areas PM2_1 to PM2_7 are arranged on the optical wave guide 112 between the optical multiplexer/demultiplexer 113 and the optical multiplexer/demultiplexer 114.

Here, the phase modulation area is an area that includes one electrode (segmented electrode) formed on the optical wave guide. An effective refractive index of the optical wave guide below the electrode is changed by applying an electric signal, e.g., a voltage signal, to the electrode. As a result, a substantial optical length of the optical wave guide in the phase modulation area can be changed. Thus, phase modulation area can change a phase of an optical signal propagating through the optical wave guide. Then, the optical signal can be modulated by providing the optical signals propagating through the two optical wave guides 111 and 112 with a phase difference. That is, the optical modulation unit 11 constitutes a binary Mach-Zehnder optical modulator that includes two arms and the segmented electrode structure.

The drive circuit 12 includes drivers 121 to 127. The drivers 121 to 127 output differential signals to the corresponding phase modulation areas as drive signals based on a binary input digital signal DIN, respectively. Specifically, the driver 121 outputs an in-phase drive signal via a switch S11 and a reverse phase drive signal via a switch S12. The driver 122 outputs the in-phase drive signal via a switch S21 and the reverse phase drive signal via a switch S22. The driver 123 outputs the in-phase drive signal via a switch S31 and the reverse phase drive signal via a switch S32. The driver 124 outputs the in-phase drive signal via a switch S41 and the reverse phase drive signal via a switch S42. The driver 125 outputs the in-phase drive signal via a switch S51 and the reverse phase drive signal via a switch S52. The driver 126 outputs the in-phase drive signal via a switch S61 and the reverse phase drive signal via a switch S62. The driver 127 outputs the in-phase drive signal via a switch S71 and the reverse phase drive signal via a switch S72.

The determination circuit 13 determines number of the drivers to be activated among the drivers 121 to 127 using a required transmitting rate information INF input from outside. The determination circuit 13 outputs a signal SIG1 specifying the drivers to be activated to the driver control circuit 14 and the switching control circuit 16.

The driver control circuit 14 activates the drivers specified by the signal SIG1. Then, the driver control circuit 14 cuts off power supply to the drivers which are not specified by the signal SIG1.

The driver-output switching circuit 15 is a circuit that receives a control signal from the switching control circuit 16 and connects the activated drivers to each phase modulation area. The driver-output switching circuit 15 includes a plurality of switches. The switch S11 is inserted between the driver 121 and the phase modulation area PM1_1. The switch S21 is inserted between the driver 122 and the phase modulation area PM1_2. The switch S31 is inserted between the driver 123 and the phase modulation area PM1_3. The switch S41 is inserted between the driver 124 and the phase modulation area PM1_4. The switch S51 is inserted between the driver 125 and the phase modulation area PM1_5. The switch S61 is inserted between the driver 126 and the phase modulation area PM1_6. The switch S71 is inserted between the driver 127 and the phase modulation area PM1_7.

The switch S12 is inserted between the driver 121 and the phase modulation area PM2_1. The switch S22 is inserted between the driver 122 and the phase modulation area PM2_2. The switch S32 is inserted between the driver 123 and the phase modulation area PM2_3. The switch S42 is inserted between the driver 124 and the phase modulation area PM2_4. The switch S52 is inserted between the driver 125 and the phase modulation area PM2_5. The switch S62 is inserted between the driver 126 and the phase modulation area PM2_6. The switch S72 is inserted between the driver 127 and the phase modulation area PM2_7.

A switch B11 is inserted between a terminal at the optical modulation unit 11 side of the switch S11 and a terminal at the optical modulation unit 11 side of the switch S21. A switch B21 is inserted between a terminal at the optical modulation unit 11 side of the switch S21 and a terminal at the optical modulation unit 11 side of the switch S31. A switch B31 is inserted between a terminal at the optical modulation unit 11 side of the switch S31 and a terminal at the optical modulation unit 11 side of the switch S41. A switch B41 is inserted between a terminal at the optical modulation unit 11 side of the switch S41 and a terminal at the optical modulation unit 11 side of the switch S51. A switch B51 is inserted between a terminal at the optical modulation unit 11 side of the switch S51 and a terminal at the optical modulation unit 11 side of the switch S61. A switch B61 is inserted between a terminal at the optical modulation unit 11 side of the switch S61 and a terminal at the optical modulation unit 11 side of the switch S71.

A switch B12 is inserted between a terminal at the optical modulation unit 11 side of the switch S12 and a terminal at the optical modulation unit 11 side of the switch S22. A switch B22 is inserted between a terminal at the optical modulation unit 11 side of the switch S22 and a terminal at the optical modulation unit 11 side of the switch S32. A switch B32 is inserted between a terminal at the optical modulation unit 11 side of the switch S32 and a terminal at the optical modulation unit 11 side of the switch S42. A switch B42 is inserted between a terminal at the optical modulation unit 11 side of the switch S42 and a terminal at the optical modulation unit 11 side of the switch S52. A switch B52 is inserted between a terminal at the optical modulation unit 11 side of the switch S52 and a terminal at the optical modulation unit 11 side of the switch S62. A switch B62 is inserted between a terminal at the optical modulation unit 11 side of the switch S62 and a terminal at the optical modulation unit 11 side of the switch S72.

An ON/OFF operation of each switch of the driver-output switching circuit 15 described above is controlled by the control signal from the switching control circuit 16.

The switching control circuit 16 controls each connection between the activated drivers specified by a signal SIG2 and the phase modulation areas in the driver-output switching circuit 15.

A required transmitting rate can be varied in the optical transmission-reception system. Thus, the optical modulator 100 changes the activated drivers according to the variation of the required transmitting rate in this embodiment. Hereinafter, a method for changing the activated drivers in the optical modulator 100 shall be described.

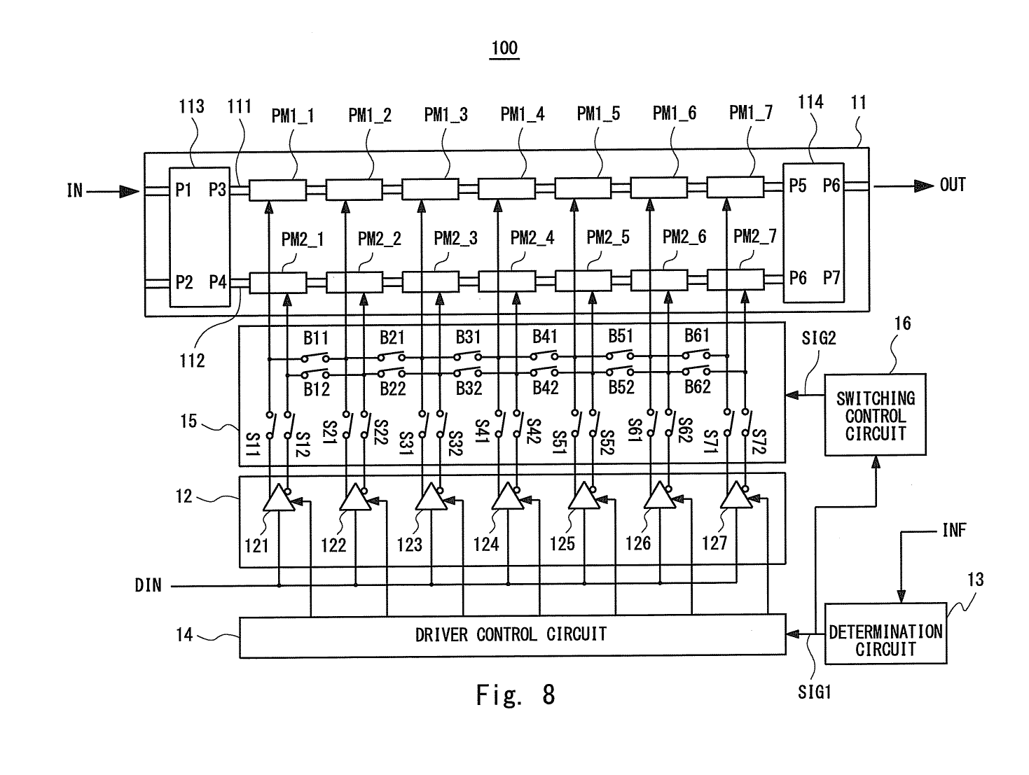

The phase modulation area of the optical modulator 100 constitutes a p-i-n (p-intrinsic-n) structure diode. The p-i-n structure diode behaves as a capacitive load when a high-frequency drive signal is applied to the p-i-n structure diode. FIG. 9 is an equivalent circuit diagram when the p-i-n structure diode behaves as the capacitive load. Considering a resistance of a wiring and so on, the driver and the p-i-n structure diode constitute an RC series circuit. Band characteristics of the series circuit and an RC time constant f1 are expressed by a following expression (1) by using a resistance value R and a capacitance value C.

f1=1/(2πRC) (1)

In the expression (1) described above, the capacitance value C has more dominant effect than the resistance value R.

Each driver drives a pair of the phase modulation areas when the required transmission rate is high. In this case, each driver has band characteristics for high required transmission rate. On the other hand, latitude is generated in the band characteristics of the driver when the required transmission rate is low. In this embodiment, one driver drives a plurality of the phase modulation areas when the required transmission rate is low. In other words, the lower the required transmission rate is, the smaller the number of the activated drivers is.

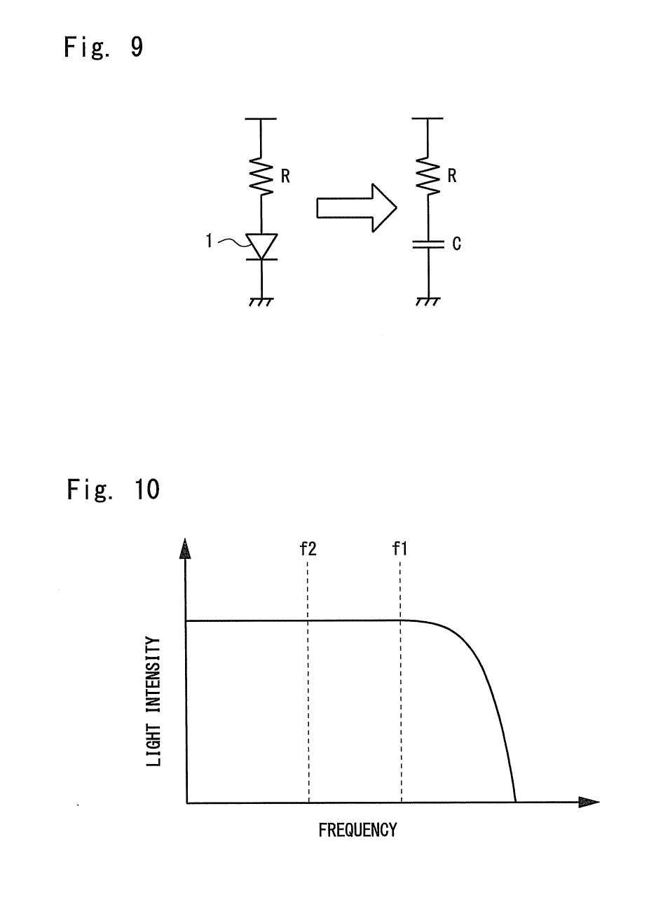

FIG. 10 is a graph showing the required transmission rate and the band characteristics of the optical modulator 100. In FIG. 10, the band characteristics of the optical modulator 100 when one driver drives a pair of the phase modulation areas are represented. When the required transmission rate is f1, as it is at the vicinity of the upper limit of the band characteristics of the optical modulator 100, one driver has to drive a pair of the phase modulation areas. However, when the required transmission rate is f2 that is smaller than f1, f2 is smaller than the upper limit of the band characteristics of the optical modulator 100. Thus, it is possible to correspond to the required transmission rate f2 even when one driver drives multiple pairs of the phase modulation areas.

In sum, the optical modulator 100 changes the number of the drivers to be used according to the transmission rate. Specifically, the optical modulator 100 modulates the optical signal by the activated drivers, and deactivates the drivers that are not used for the modulation and cuts off the power supply thereto. Hereinafter, the activation of the driver means providing the driver with the power supply and letting the driver output the drive signal to the phase modulation area from the driver. The deactivation of the driver means cutting off the power supply to the driver.

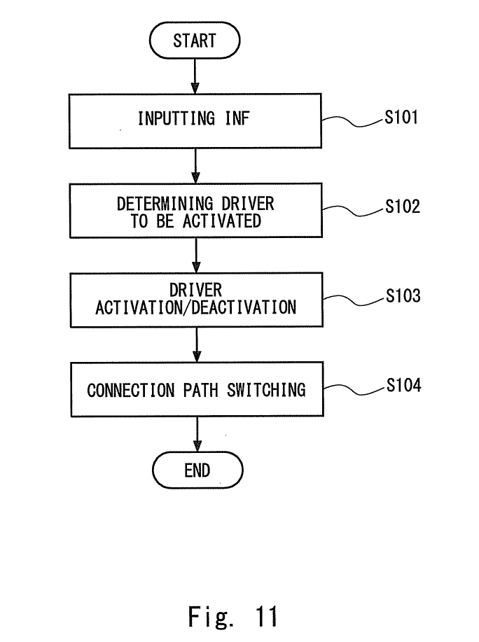

FIG. 11 is a flowchart showing a method for determining the activated driver in the optical modulator 100.

### Step S101

Firstly, the required transmission rate information INF is input to the determination circuit 13 from outside. The required transmission rate information INF may be output from an optical receptor or the optical transmission/reception system and supplied as setting information from a user.

### Step S102

The determination circuit 13 determines the drivers to be activated among the drivers 121 to 127 according to the required transmission rate information INF. Then, the determination circuit 13 outputs the signal SIG1, which specifies the drivers to be activated, to the driver control circuit 14 and the switching control circuit 16.

### Step S103

The driver control circuit 14 activates the driver specified by the signal SIG1 and cuts off the power supply to the other drivers.

### Step S104

The switching control circuit 16 switches the connection path between the drivers and the phase modulation areas by the signal SIG2. Therefore, there is the driver connected to two or more pares of the phase modulation areas in the activated drivers.

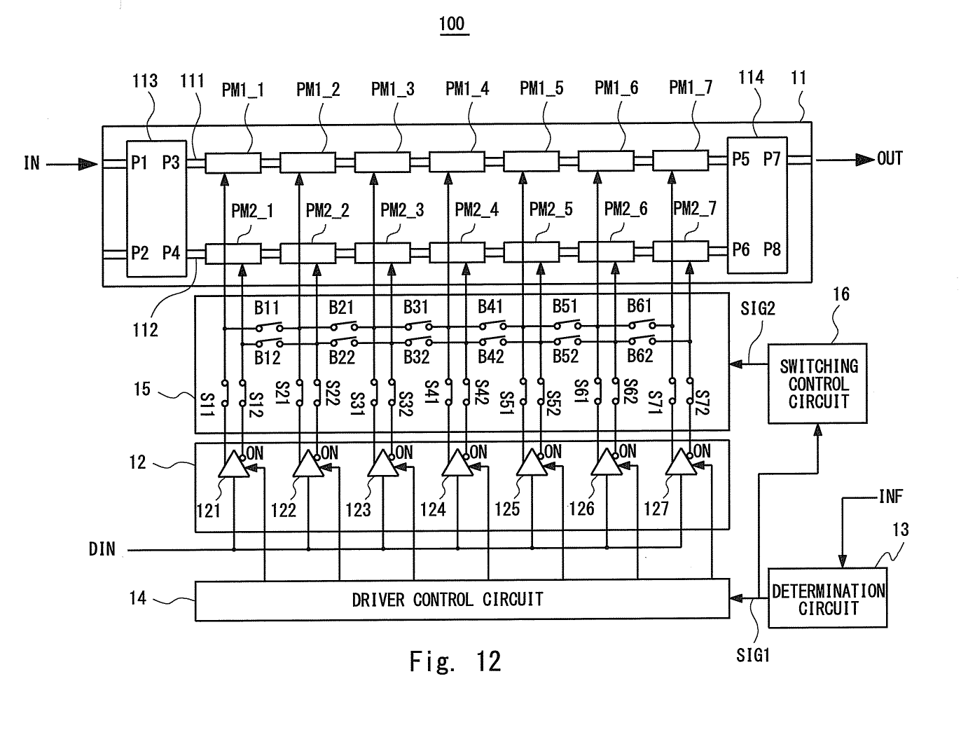

Next, a selection of the activated drivers and the deactivated drivers in the optical modulator 100 shall be described. FIG. 12 is a plane view of the optical modulator 100 when the required transmission rate is high (e.g., f1 in FIG. 10). In FIG. 12, the activated driver is indicated by “ON”. In this case, all of the drivers 121 to 127 are activated, and connected to a pair of the phase modulation areas, respectively.

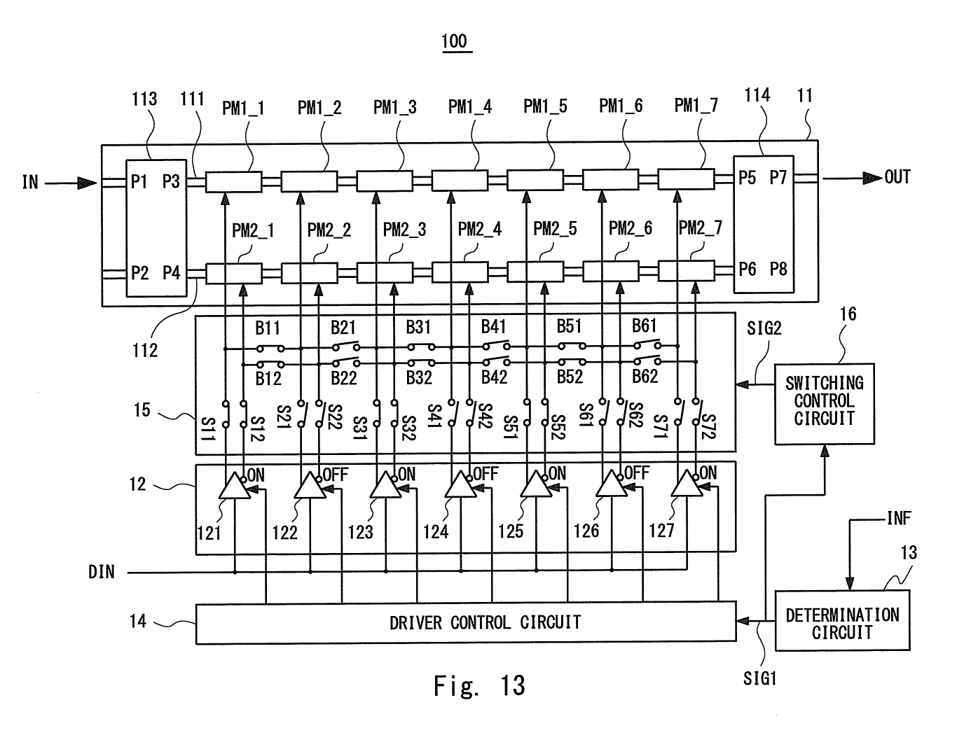

Next, the selection of the activated drivers and the deactivated drivers in the optical modulator 100 shall be described. FIG. 13 is a plane view of the activated drivers and the deactivated drivers of the optical modulator 100 when the required transmission rate is low (e.g., f2 in FIG. 10). Here, the case that four drivers are activated and the three drivers are deactivated is described. In FIG. 13, the activated driver is indicated by “ON” and the deactivated driver is indicated by “OFF”. As shown in FIG. 13, the drivers 121, 123, 125, and 127 are activated, and the drivers 122, 124, and 126 are deactivated in the optical modulator 100.

In this case, the switching control circuit 16 switches the connection path of the driver-output switching circuit 15. Thus, the driver 121 is connected to the phase modulation areas PM1_1, PM2_1, PM1_2, and PM2_2. The driver 123 is connected to the phase modulation areas PM1_3, PM2_3, PM1_4, and PM2_4. The driver 125 is connected to the phase modulation areas PM1_5, PM2_5, PM1_6, and PM2_6. That is, the drivers 121, 123, 125 drive two pairs of the phase modulation area.

According to the configuration, the binary optical signal can be transmitted by driving merely minimal number of drivers in the range capable of corresponding to the required transmission rate. Thus, it is possible to cut off the power supply to the drivers that are not used and suppress the power consumption in the drivers. The driver generally has relatively large circuit scale and the power consumption thereof is large. Therefore, the power consumption can be easily suppressed by cutting off the power supply to the drivers as appropriate.

### Second Embodiment

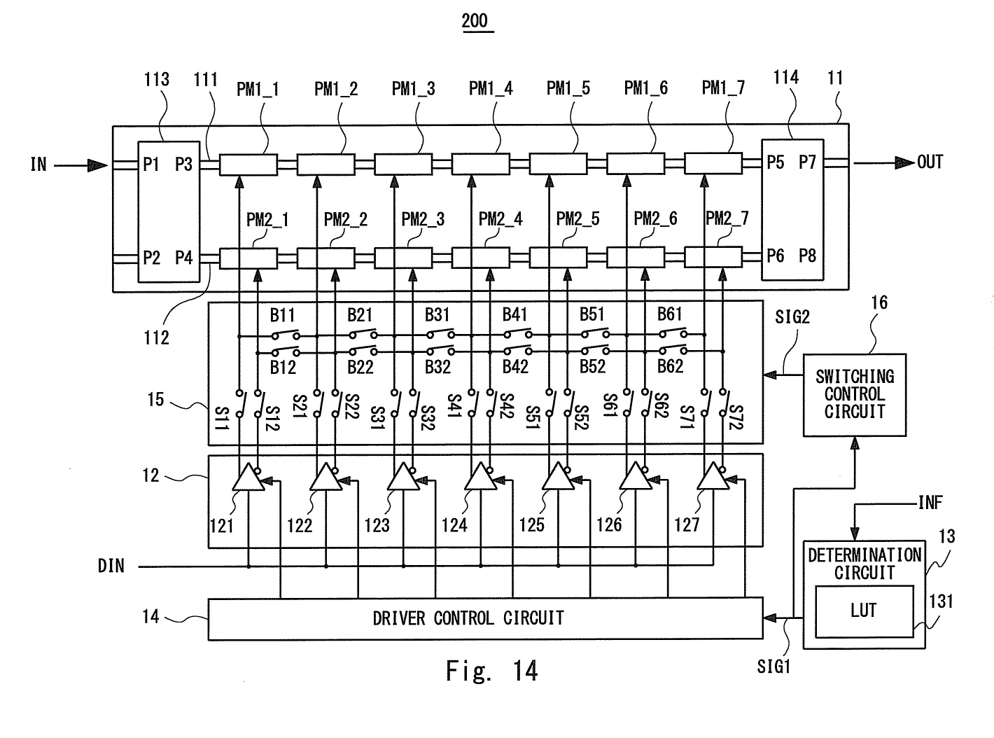

Next, an optical modulator 200 according to a second embodiment of the present invention shall be described. The optical modulator 200 is a specific example of the optical modulator 100 according to the second embodiment. FIG. 14 is a plane view schematically showing a configuration of the optical modulator 200. The determination circuit 13 includes a look-up table (LUT) 131 in the optical modulator 200.

The LUT 131 stores information associating the required transmission rate information INF with the drivers to be activated. The LUT 131 is stored in a memory device provided in the determination circuit 13. The LUT 131 may be stored in the determination circuit 13 in advance, input from the optical receptor or the optical transmission/reception system, or supplied as the setting information from the user.

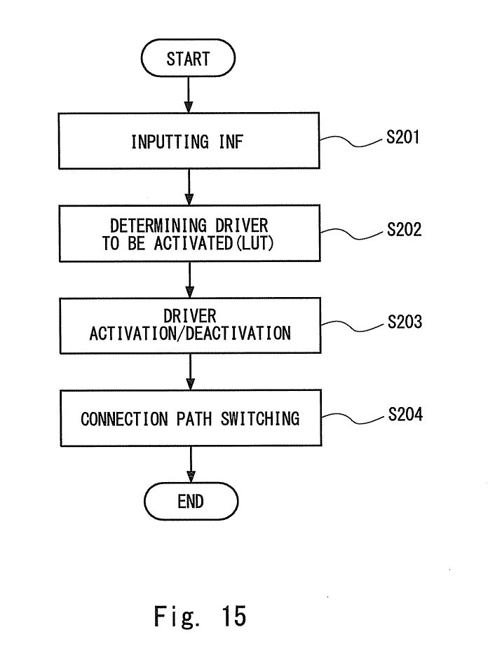

FIG. 15 is a flowchart showing a method for deciding the activated driver in the optical modulator 200.

### Step S201

The step S201 is the same as the step S101 of the FIG. 11, thereby a description thereof is omitted.

### Step S202

The determination circuit 13 checks the required transmission rate information INF against the LUT 131 and determines the drivers to be activated among the drivers 121 to 127. Then, the determination circuit 13 outputs the signal SIG1 specifying the drivers to be activated to the driver control circuit 14.

### Steps S203 and S204

The steps S203 and S204 are the same as the steps S103 and S104 of FIG. 11, thereby descriptions thereof are omitted.

According to the configuration, the optical signal having an appropriate multivalued-level can be transmitted to the optical receptor by driving merely minimal number of drivers in the range capable of corresponding to the required transmission rate as in the case of the first embodiment. Thus, it is possible to cut off the power supply to the drivers that are not used and suppress the power consumption in the drivers.

### OTHER EMBODIMENTS

The present invention is not limited to the above-described exemplary embodiments, and can be modified as appropriate without departing from the scope of the invention. For example, in the embodiments described above, the connection switching between the driver and the phase modulation area may executed as an initial setting at the time of introduction, or executed as a fine adjustment in the currently-operated optical transmission/reception system at a predetermined timing and frequency.

The deactivated drivers can be appropriately rotated in the embodiments described above. It is possible to extend a life from a view point of a whole drive circuit by averaging frequency of deactivation of the drivers provided in the plural number.

The technique described in the above-mentioned embodiments in which the power consumption is decreased by cutting off the power supply to the activated drivers can be applied to not only one Mach-Zehnder optical modulator but also an I (In-phase)/Q (Quadrature) optical modulator.

In the above-mentioned embodiments, an example in which one activated driver is connected to the phase modulation areas that are previously connected to the deactivated driver in the case of the low transmission rate is described. However, it is merely an example. That is, one activated driver may be connected to phase modulation areas that are previously connected to two or more deactivated drivers in the case of the low transmission rate, as long as the requested transmission rate is satisfied. Thus, it is possible to provide two or more phase modulation areas on one optical wave guide of the optical modulator and two or more drivers, and connect the activated driver to two or more phase modulation areas.

The present invention has been described above with reference to exemplary embodiments, but the present invention is not limited to the above exemplary embodiments. The configuration and details of the present invention can be modified in various manners which can be understood by those skilled in the art within the scope of the invention.

This application is based upon and claims the benefit of priority from Japanese patent application No. 2012-278048, filed on Dec. 20, 2012, the disclosure of which is incorporated herein in its entirety by reference.

### REFERENCE SIGNS LIST

11, 61 OPTICAL MODULATION UNIT
12 DRIVE CIRCUIT
13, 63 DETERMINATION CIRCUITS
14 DRIVER CONTROL CIRCUIT
15 DRIVER CONTROL CIRCUIT
16 SWITCHING CONTROL CIRCUIT
62 DECODE UNIT
100, 200 OPTICAL MODULATORS
111, 112, 611, 612 OPTICAL WAVE GUIDES
113, 114, 613, 614 OPTICAL MULTIPLEXERS/DEMULTIPLEXERS
121-127, DR61-DR67 DRIVERS
131 LOOK-UP TABLE (LUT)
1000, 6000 OPTICAL TRANSMITTERS
1001, 6001 LIGHT SOURCES
1002, 6002 CW LIGHTS
1003, 6003 OPTICAL SIGNALS
DIN INPUT DIGITAL SIGNAL
IN INPUT LIGHT
INF REQUIRED TRANSMISSION RATE INFORMATION
OUT OPTICAL SIGNAL
P1, P2, P5, P6 INPUT PORTS
P3, P4, P7, P8 OUTPUT PORTS
PM1_1-PM1_7, PM2_1-PM2_7, PM61_1-PM61_7, PM62_1-PM62_4 PHASE MODULATION AREAS
S11, S12, S21, S22, S31, S32, S41, S42, S51, S52, S61, S62, S71, S72,
B11, B12, B21, B22, B31, B32, B41, B42, B51, B52, B61, B62 SWITCHES

What is claimed is:

1. An optical modulator comprising:
an optical modulation unit that outputs an optical signal generated by binary-modulating an input light, a plurality of phase modulation areas being formed on an optical wave guide in the optical modulation unit;
a drive circuit that includes a plurality of drivers outputting drive signals according to an input digital signal to the plurality of the phase modulation areas;
a determination circuit that determines the driver to be activated among the plurality of the drivers based on information expressing a transmission rate;
a driver control circuit that activates the driver specified by a result of a determination of the determination circuit and cuts off power supply to the driver other than the activated driver;
a switching circuit that switches connections between the plurality of the drivers and the plurality of the phase modulation areas; and
a switching control circuit that controls the switching circuit to cause the drive signals to be applied from the activated driver to the plurality of the phase modulation areas.

2. The optical modulator according to claim 1, wherein
the determination circuit comprises a table associating the transmission rate with the drivers to be activated, and checks information expressing the transmission rate against the table to determine the driver to be activated.

3. The optical modulator according to claim 1, wherein
the determination circuit decreases number of the activated drivers with decreasing the transmission rate expressed by the information expressing the transmission rate.

4. The optical modulator according to claim 1, wherein
the optical modulation unit propagates two-divided input lights through the two optical wave guides, respectively, and generates the optical signal by multiplexing the two-divided input lights after phase-modulating either or both of the two-divided input lights.

5. The optical modulator according to claim 4, wherein
the optical modulation unit comprises:
a first optical multiplexer/demultiplexer that divides the input light into a first input light and a second input light;
a first optical wave guide through which the first input light propagates;
a second optical wave guide through which the second input light propagates;
a second optical multiplexer/demultiplexer that outputs the optical signal by multiplexing a light output from the first optical wave guide and a light output from the second optical wave guide;
a plurality of first phase modulation areas that are formed on the first optical wave guide; and
a plurality of second phase modulation areas that are formed on the second optical wave guide.

6. The optical modulator according to claim 5, wherein
the optical modulation unit comprises:
the m (m is an integer equal to or more than two) first phase modulation areas; and
the m second phase modulation areas,
the drive circuit comprises the m drivers, and
there is at least one driver in the activated drivers in the m drivers that is connected to the n (n is an integer equal to or more than two) first phase modulation areas and the n second phase modulation areas without overlapping with the other activated drivers.

7. An optical transmitter comprising:
an optical modulation unit that outputs an optical signal generated by binary-modulating an input light, a plurality of phase modulation areas being formed on an optical wave guide in the optical modulation unit;
a light source that outputs the input light;
a drive circuit that includes a plurality of drivers outputting drive signals according to an input digital signal to the plurality of the phase modulation areas;
a determination circuit that determines the driver to be activated among the plurality of the drivers based on information expressing a transmission rate;
a driver control circuit that activates the driver specified by a result of a determination of the determination circuit and cuts off power supply to the driver other than the activated driver;
a switching circuit that switches connections between the plurality of the drivers and the plurality of the phase modulation areas; and
a switching control circuit that controls the switching circuit to cause the drive signals to be applied from the activated driver to the plurality of the phase modulation areas.

8. An optical transmission/reception system comprising:
an optical transmitter that outputs an optical signal; and
an optical receptor that receives the optical signal, wherein
the optical transmitter comprises:
an optical modulation unit that outputs the optical signal generated by binary-modulating an input light, a plurality of phase modulation areas being formed on an optical wave guide in the optical modulation unit;
a light source that outputs the input light;
a drive circuit that includes a plurality of drivers outputting drive signals according to an input digital signal to the plurality of the phase modulation areas;
a determination circuit that determines the driver to be activated among the plurality of the drivers based on information expressing a transmission rate;
a driver control circuit that activates the driver specified by a result of a determination of the determination circuit and cuts off power supply to the driver other than the activated driver;
a switching circuit that switches connections between the plurality of the drivers and the plurality of the phase modulation areas; and
a switching control circuit that controls the switching circuit to cause the drive signals to be applied from the activated driver to the plurality of the phase modulation areas.

9. A control method for an optical modulator comprising;
determining driver to be activated among a plurality of the drivers, the plurality of the drivers outputting drive signals according to an input digital signal to a plurality of phase modulation areas formed on an optical wave guide based on information expressing a transmission rate, the plurality of phase modulation areas modulating an input light that propagates through the optical wave guide;
activating the driver specified by the determination, and cutting off power supply to the driver other than the activated driver; and
switching connections between the plurality of the drivers and the plurality of the phase modulation areas to cause the drive signals to be applied from the activated driver to the plurality of the phase modulation areas.
